(19) United States
(12) Patent Application Publication
(10) Pub. No.: US 2013/0288043 A1
(43) Pub. Date: Oct. 31, 2013

(54) HOUSING AND METHOD FOR MAKING HOUSING

(71) Applicants: SHU-XIANG ZHOU, Shenzhen City (CN); ZHI-QING ZOU, Shenzhen City (CN); QIU-JIANG XU, Shenzhen City (CN); HE-XIAN LIN, Shenzhen City (CN)

(72) Inventors: SHU-XIANG ZHOU, Shenzhen City (CN); ZHI-QING ZOU, Shenzhen City (CN); QIU-JIANG XU, Shenzhen City (CN); HE-XIAN LIN, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/524,322

(22) Filed: Jun. 15, 2012

(30) Foreign Application Priority Data
Apr. 25, 2012 (CN) 201210123015.8

(51) Int. Cl. B05D 1/02; B32B 5/02; B05D 3/02; B32B 9/00; B82Y 30/00

(52) U.S. Cl. 428/336; 427/397.7; 427/565; 428/421; 977/773

(57) ABSTRACT

A method for making a housing includes the following steps: modifying nano silicon dioxide using thirteen fluorine octyltriethoxysilane to make fluoroalkyl-modified nano silicon dioxide; mixing the fluoroalkyl-modified nano silicon dioxide, an organic solvent, and a filmogen together to make a coating solution; providing a plastic substrate; spraying the coating solution to the surface of the plastic substrate and drying to make a layer.

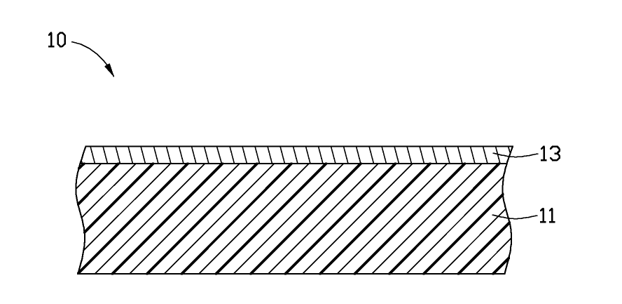

### BACKGROUND

1. Technical Field

The present disclosure relates to a housing and a method for making the housing.

2. Description of Related Art

Housings of electronic devices are usually spray painted to form decorative and/or protective paint coatings. However, the paint coatings have poor resistance against contamination.

Therefore, there is room for improvement within the art.

### BRIEF DESCRIPTION OF THE FIGURE

Many aspects of the housing can be better understood with reference to the following drawing. The components in the drawing are not necessarily drawn to scale, the emphasis instead being placed upon clearly illustrating the principles of the housing. Moreover, in the drawing like reference numerals designate corresponding parts throughout the drawing.

The figure is a cross-sectional view of an exemplary embodiment of a housing.

### DETAILED DESCRIPTION

The figure shows a housing 10 according to an exemplary embodiment. A method for making the housing 10 may include at least the following steps.

Spherically shaped nano silicon dioxides are ultrasonically dispersed in an organic solvent, then thirteen fluorine octyltriethoxysilane (hearinafter “TFOT”) is added to make a mixture. The mixture is stirred for about 3 hours to about 5 hours, followed by a filtering process to separate out a fluoroalkyl-modified nano silicon dioxide. The fluoroalkyl-modified nano silicon dioxide has a low surface energy.

The ratio of the nano silicon dioxide, the organic solvent, and the TFOT is about 2 gram (g) to about 3 g of the nano silicon dioxide, the organic solvent may have a volume of about 30 ml to about 45 ml, and the TFOT may have a volume of about 0.1 ml to about 0.15 ml. The nano silicon dioxide has a particle size in a range of about 50 nm to about 120 nm.

The organic solvent can be, for example, isopropyl alcohol or ethanol, but not limited to the two substances. The organic solution acts as a diluent.

The fluoroalkyl-modified nano silicon dioxide, an organic solvent, and a filmogen are mixed uniformly to make a coating solution. The ratio of the fluoroalkyl-modified nano silicon dioxide, the organic solvent, and the filmogen is about 2 g to about 3 g of the fluoroalkyl-modified nano silicon dioxide, the filmogen has a mass of about 0.5 g to about 0.75 g, and the organic solvent has a volume of about 50 ml to about 75 ml.

The filmogen is benzenethionosulfonic acid sodium salt. The organic solvent can be, for example, isopropyl alcohol or ethanol, but not limited to the two substances. The organic solution acts as a diluent.

A plastic substrate 11 is provided and cleaned.

The coating solution is spray painted on the surface of the plastic substrate 11 using a spray gun, then the substrate 11 is dried at an environment temperature of about 80° C. to about 120° C. for about 25 min to about 40 min to form a layer 13 on the substrate 11. The layer 13 has a thickness of about 150 nm to about 300 nm. The layer 13 contains fluoroalkyl-modified silicon dioxide.

The housing 10 shown in the figure includes the plastic substrate 11 and the layer 13 formed on the plastic substrate 11. The layer 13 contains fluoroalkyl-modified silicon dioxide. The layer 13 has a thickness of about 150 nm to about 300 nm. The contact angle of water to the layer 13 is more than 110°, thus the layer 13 has a good hydrophobic property, providing the housing 10 excellent contamination resistance.

### EXAMPLE

Experimental example of the present disclosure is described as follows.

The nano silicon dioxide having a mass of about 2 g was ultrasonically dispersed in ethanol having a volume of about 30 ml, then the TFOT having a volume of about 0.1 ml was added to make a mixture. The mixture was stirred for about 5 hours, and then filtered to separate out a fluoroalkyl-modified nano silicon dioxide.

The fluoroalkyl-modified nano silicon dioxide having a mass of 2 g, ethanol having a volume of 50 ml, and benzenethionosulfonic acid sodium salt having a mass of 0.5 g were mixed to make a coating solution.

The coating solution was spray painted on the plastic substrate 11 with a spray gun, then the substrate 11 was dried at an environment temperature of about 100° C. for about 30 min to form the layer 13 on the substrate 11.

The housing 10 of the example was left standing for about 24 hours, then a water contact angle test was performed. The test showed that the water contact angle was about 112°, which indicated the housing 10 had a good resistance against contamination.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A method for making a housing, comprising:
forming fluoroalkyl-modified nano silicon dioxide by using thirteen fluorine octyltriethoxysilane to modify nano silicon dioxide;
forming a coating solution by mixing the fluoroalkyl-modified nano silicon dioxide, an organic solvent, and a filmogen, the ratio of the fluoroalkyl-modified nano silicon dioxide, the organic solvent, and the filmogen being that when there is about 2 g to about 3 g fluoroalkyl-modified nano silicon dioxide, the filmogen has a mass of about 0.5 g to about 0.75 g, and the organic solvent has a volume of about 50 ml to about 75 ml;
providing a plastic substrate;
spray painting the coating solution on the surface of the plastic substrate and drying the coating to form a layer on the substrate.

2. The method as claimed in claim 1, wherein the step of forming fluoroalkyl-modified nano silicon dioxide comprises: ultrasonically dispersing nano silicon dioxide in an organic solvent, then forming a mixture by adding thirteen octyltriethoxysilane; stirring the mixture for about 3 hours to about 5 hours, then filtering to separate out the fluoroalkyl-modified nano silicon dioxide.

3. The method as claimed in claim 2, wherein ratio of the nano silicon dioxide, the organic solvent, and the thirteen fluorine octyltriethoxysilane, is that when there is about 2 g to about 3 g nano silicon dioxide, the organic solvent has a volume of about 30 ml to about 45 ml, and the thirteen fluorine octyltriethoxysilane has a volume of about 0.1 ml to about 0.15 ml.

4. The method as claimed in claim 3, wherein the organic solvent is isopropyl alcohol or ethanol.

5. The method as claimed in claim 1, wherein the nano silicon dioxide has a particle size in a range of about 50 nm to about 120 nm.

6. The method as claimed in claim 1, wherein the filmogen is benzenethionosulfonic acid sodium salt.

7. The method as claimed in claim 1, wherein the organic solvent is isopropyl alcohol or ethanol.

8. The method as claimed in claim 1, wherein drying the coating solution is carried out at an environment temperature of about 80° C. to about 120° C. for about 25 min to about 40 min.

9. The method as claimed in claim 1, wherein the layer has a thickness of about 150 nm to about 300 nm.

10. A housing, comprising:
a plastic substrate; and
a layer formed on the plastic substrate, the layer containing fluoroalkyl-modified silicon dioxide.

11. The coated article as claimed in claim 10, wherein the layer has a thickness of about 150 nm to about 300 nm.

12. The coated article as claimed in claim 10, wherein the layer has a water contact angle of more than 110°.
